(19) United States
(12) Patent Application Publication
(10) Pub. No.: US 2022/0129907 A1
(43) Pub. Date: Apr. 28, 2022

(54) System and method for Automatic Update of Customer Relationship Management and Enterprise Resource Planning Fields with Next Best Actions using Machine Learning

(71) Applicant: Aviso INC., Redwood City, CA (US)

(72) Inventors: Joy MUSTAFI, Hyderabad (IN); Sayan Deb KUNDU, Kolkata (IN); Gopikrishna NUTI, Bachupally (IN); Trevor RODRIGUES, Scottsdale, AZ (US)

(73) Assignee: Aviso LTD., Redwood City, CA (US)

(21) Appl. No.: 17/082,879

(22) Filed: Oct. 28, 2020

(51) Int. Cl. G06Q 30/00; G06N 20/00; G06Q 10/06; G06Q 30/02

(52) U.S. Cl. CPC G06Q 30/016; G06N 20/00; G06Q 30/0281; G06Q 30/0201; G06Q 10/06398

(57) ABSTRACT

The present invention is related to a system and method for automatic updates of customer relationship management and enterprise resource planning fields with the next best actions using machine learning. A system processing unit (106) of a server computer (104), executes computer-readable instructions to retrieve data from a customer relationship management database (102), a calls log and email database (108), an enterprise resource planning database (110), and data from external sources. The system processing unit (106) executes computer-readable instruction to integrate all data into the datasets and feed the datasets into a machine learning analytical module to train the machine learning analytical module. The trained machine learning analytical module analyses various information that suggests the next best actions to be taken. The trained machine learning analytical module updates the customer relationship management database (102), the calls log and email database (108), the enterprise resource planning database (110) based on the action taken by the sales representative.

### FIELD OF INVENTION

The present invention relates to a system and methods for auto-updating and suggesting the next best action in sales deal, and more specifically relates to a system and method for automatic update of customer relationship management and enterprise resource planning fields with next best actions using machine learning.

Multiple companies have been operating in the same field nowadays. Thus there is huge competition in the market. The companies have to Even with a slight delay in making the decision, results in loss of the sales deals. If there is a large company, then it is also difficult to make a decision quickly. Some it is difficult to find under performance of sales representative and factor affecting sales representative performance. Thus ultimately the sales target of a particular sales representative does not achieve. To manage customer and sales, there is a CRM system.

But there is huge data in CRM. Most CRMs are not updated regularly because that needs to be updated manually. A company with huge sales data is difficult to update the data regularly. Thus that also delays sales decisions making high authority lately come to know about problems in sales. Also reading huge data to understand the market takes a long, thus leads to loss of opportunity.

Patent application US20170124492A1 discloses a system for fully integrated collection of business impacting data, analysis of that data and generation of both analysis-driven business decisions and analysis-driven simulations of alternate candidate business actions. This business operating system may be used predict the outcome of enacting candidate business decisions based upon past and current business data retrieved from both within the corporation and from a plurality of external sources pre-programmed into the system. Simulations using this data and predefined parameters to create models of actors are then run. The risk to value estimates of candidate decisions is also calculated.

The existing invention does not provide auto-updating of the CRM. The existing invention does not provide detailed suggestions related to sales. This is within the aforementioned context that a need for the present invention has arisen. Thus, there is a need to address one or more of the foregoing disadvantages of conventional systems and methods, and the present invention meets this need.

### SUMMARY OF THE INVENTION

The present invention is related to a system and method for automatic updates of customer relationship management and enterprise resource planning fields with the next best actions using machine learning. The method includes:

A method of extracting data, the method having:

A system processing unit of a server computer executes computer-readable instructions that use extract, transform, load functions to retrieve data from a customer relationship management database, a calls log and email database, an enterprise resource planning database, and data from external sources. The system processing unit executes computer-readable instruction to create datasets that include past deals history, the action that was taken, final results related to deals. The system processing unit executes computer-readable instruction to refine and quantify the dataset. Further, the system processing unit executes computer-readable instruction to integrate all the datasets and feed the datasets into a machine learning analytical module. Thus the machine learning analytical module learns from the datasets. Further, the machine learning analytical module is tested and optimized. The trained machine learning analytical module is stored in a system server memory of the server computer. In the preferred embodiment, the external sources are the public internet database from where data is being extracted.

A method for an automated suggestion for the next best action in sales, the method having:

The system processing unit of the server computer executes computer-readable instruction to extract data from the customer relationship management database and feed into the trained machine learning analytical module. The trained machine learning analytical module analyses various information related to the current opportunity and compares with similar opportunities in the past, and further automatically decides the opportunity information that is relevant for making the decision. The system processing unit of the server computer executes computer-readable instruction to further extract data from the external sources and feed into the trained machine learning analytical module. The trained machine learning analytical module analysis analyses various information related to opportunities and competition in the external market as well. The trained machine learning analytical module identifies the next best actions to be taken, and the trained machine learning analytical module identifies those actions also that should not be taken. The trained machine learning analytical module with help of the system processing unit sends a suggestion to the sales representative on stakeholders to be included in the next best action to be taken, The trained machine learning analytical module with help of the system processing unit sends the suggestion to the sales representative on the tone of communication to be had with the stakeholders based on previous information. The trained machine learning analytical module with help of the system processing unit suggests detailed activities that need to be undertaken in the next best action. The trained machine learning analytical module with help of the system processing unit suggests a deadline for the next best action.

A method for automated automatic update of the customer relationship management database, the calls log and email database, and the enterprise resource planning database, the method having:

The trained machine learning analytical module with help of the system processing unit sends a regular reminder to the sales representative for the next best action until the sales representative completes the next best action within the deadline. The trained machine learning analytical module with help of the system processing unit updates the customer relationship management database, the calls log and email database, the enterprise resource planning database based on the action taken by the sales representative. The trained machine learning analytical module with help of the system processing unit also sends higher authorities about the action taken by the sales representative on the suggested next best action and also sends sales representative performance data.

The main advantage of the present invention is that the present invention provides a statistically verifiable solution which has yielded positive results.

Yet another advantage of the present invention is that the present invention automates the next best action items in CRM to eliminate the manual process of guessing the best action that is to be taken to win a deal.

Yet another advantage of the present invention is that the present invention provides the instructions regarding the action item explaining the details of the action to be taken.

Yet another advantage of the present invention is that the present invention provides evidence to support the action to be taken.

Yet another advantage of the present invention is that the present invention gives a reminder for the action to be taken and automatically update CRM and ERP.

Further objectives, advantages, and features of the present invention will become apparent from the detailed description provided hereinbelow, in which various embodiments of the disclosed invention are illustrated by way of example.

### BRIEF DESCRIPTION OF THE DRAWINGS

The accompanying drawings are incorporated in and constitute a part of this specification to provide a further understanding of the invention. The drawings illustrate one embodiment of the invention and together with the description, serve to explain the principles of the invention.

FIG. 1 illustrates a flowchart of the method of the present invention.

FIG. 2 illustrates the system of the present invention.

### DETAILED DESCRIPTION OF THE INVENTION

### Definition

The terms “a” or “an”, as used herein, are defined as one or as more than one. The term “plurality”, as used herein, is defined as two as or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended. The term “comprising” is used interchangeably used by the terms “having” or “containing”.

Reference throughout this document to “one embodiment”, “certain embodiments”, “an embodiment”, “another embodiment”, and “yet another embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics are combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps, or acts are in some way inherently mutually exclusive.

As used herein, the term “one or more” generally refers to, but not limited to, singular as well as the plural form of the term.

The drawings featured in the figures are to illustrate certain convenient embodiments of the present invention and are not to be considered as a limitation to that. The term “means” preceding a present participle of operation indicates the desired function for which there is one or more embodiments, i.e., one or more methods, devices, or apparatuses for achieving the desired function and that one skilled in the art could select from these or their equivalent because of the disclosure herein and use of the term “means” is not intended to be limiting.

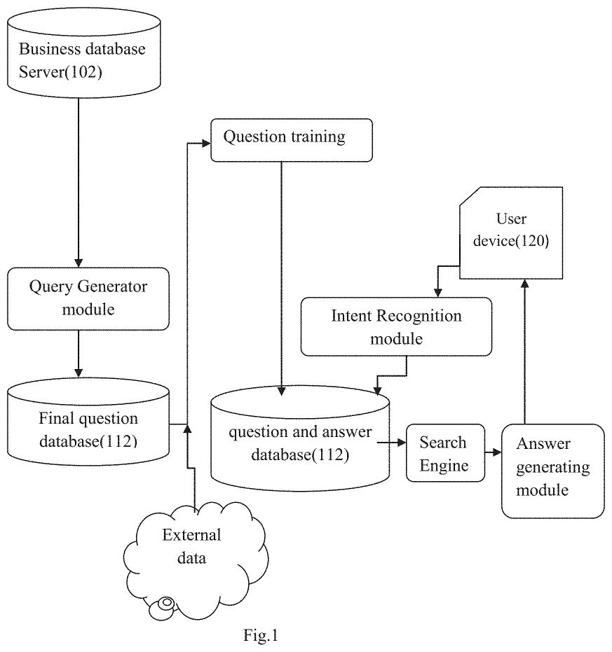

FIG. 1 illustrates the Architecture of the method for automatic update of customer relationship management and enterprise resource planning fields with the next best actions using machine learning. A system processing unit (106) of a server computer (104), executes computer-readable instructions that use extract, transform, load functions to retrieve data from a customer relationship management database (102), a calls log and email database (108), an enterprise resource planning database (110), and data from external sources. In the preferred embodiment, data that are being extracted from the customer relationship management database (102), the enterprise resource planning database (110), and the external sources, includes, but not limited to, a historical record of action items, historical and active opportunities data, direct signals from CPQ systems, and market events from the third-party sources. In the preferred embodiment, data that are being extracted from the calls log and email database (108) includes, but is not limited to, an email and call recordings of sales representative. the system processing unit (106) executes computer-readable instruction to create datasets that include past deals history, the action that was taken, final results related to deals. The system processing unit (106) executes computer-readable instruction to refine and quantify the dataset. Further, the system processing unit (106) executes computer-readable instruction to integrate all the datasets and feed the datasets into a machine learning analytical module. Thus the machine learning analytical module learns from the datasets. the system processing unit (106) of the server computer (104) executes computer-readable instruction to extract data from the customer relationship management database (102) and feed into the trained machine learning analytical module. The system processing unit (106) of the server computer (104) executes computer-readable instruction to further extract data from the external sources and feed into the trained machine learning analytical module. The trained machine learning analytical module identifies the next best actions to be taken, and the trained machine learning analytical module identifies those actions also that should not be taken

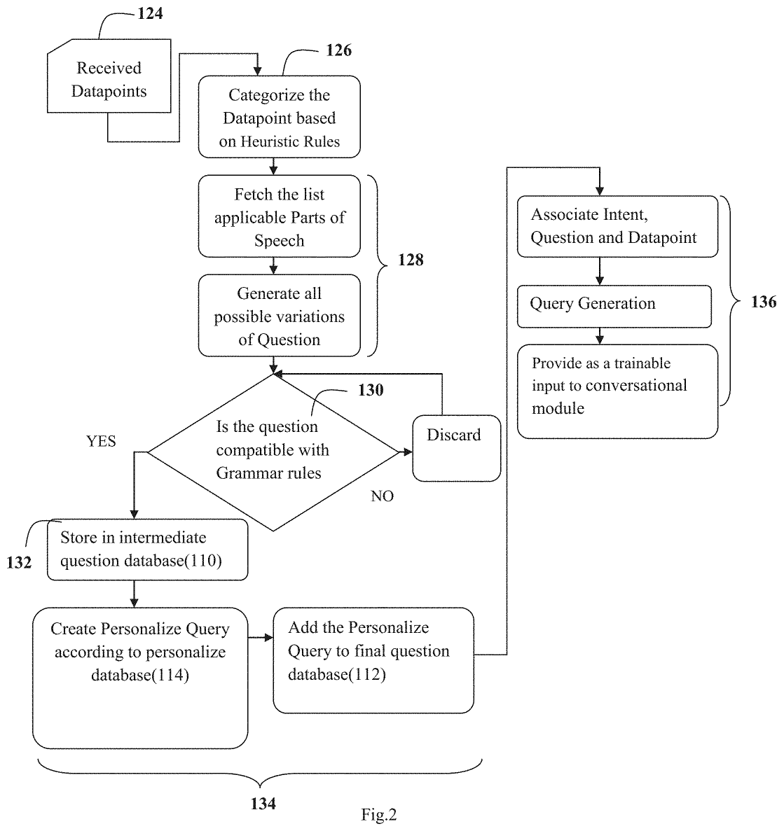

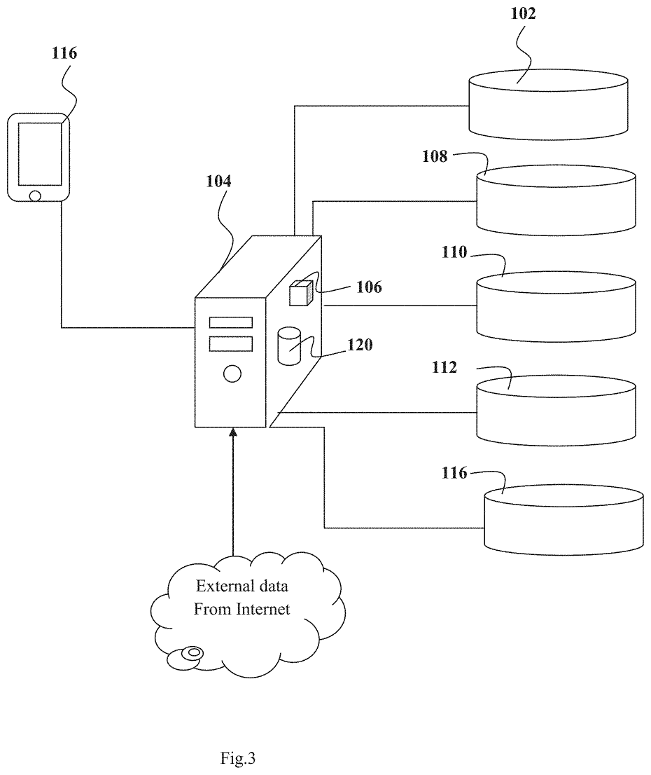

FIG. 2 illustrates a flow chart of a system and method for automatic update of customer relationship management and enterprise resource planning fields with the next best actions using machine learning. In step (120), a system processing unit (106) of a server computer (104), executes computer-readable instructions that use extract, transform, load functions to retrieve data from a customer relationship management database (102), a calls log, and email database (108), an enterprise resource planning database (110), and data from external sources. In step (122), the system processing unit (106) executes computer-readable instruction to create datasets that include past deals history, the action that was taken, final results related to deals. In step (124), the system processing unit (106) executes computer-readable instruction to refine and quantify the dataset. In step (126), further, the system processing unit (106) executes computer-readable instruction to integrate all the datasets and feed the datasets into a machine learning analytical module, thus the machine learning analytical module learns from the datasets. In step (128), the trained machine learning analytical module analyses various information related to the current opportunity and compares with similar opportunities in the past, and further automatically decides the opportunity information that is relevant for making the decision. In step (130), the trained machine learning analytical module identifies the next best actions to be taken, and the trained machine learning analytical module identifies those actions also that should not be taken. In step (130), the trained machine learning analytical module with help of the system processing unit (106) sends a regular reminder to the sales representative for the next best action until the sales representative completes the next best action within the deadline.

FIG. 3 illustrates the hardware of the method for automatic updates of customer relationship management and enterprise resource planning fields with the next best actions. The system (100) includes a customer relationship management database (102), a calls log and email database (108), an enterprise resource planning database (110), a server computer (104), a user device (112). The server computer (104) includes a system processing unit (106), and a system server memory (120). The user device (l 12) is connected to the server computer (104). The customer relationship management database (102), the call log, and email database (108), the enterprise resource planning database (110) are all connected to the server computer (104). In the preferred embodiment, the external sources are the public internet database (118) from where data is being extracted by the system processing unit (106).

The present invention is related to a system and method for automatic updates of customer relationship management and enterprise resource planning fields with the next best actions using machine learning. The method includes:

A method of extracting data, the method having:
a system processing unit of a server computer, executes computer-readable instructions that use extract, transform, load functions to retrieve data from a customer relationship management database, a calls log and email database, an enterprise resource planning database, and data from external sources;
the system processing unit executes computer-readable instruction to create datasets that include past deals history, the action that was taken, final result related to deals;
the system processing unit executes computer-readable instruction to refine and quantify the dataset;
further, the system processing unit executes computer-readable instruction to integrate all the datasets and feed the datasets into a machine learning analytical module;
thus the machine learning analytical module learns from the datasets;
further, the machine learning analytical module is tested and optimized; and
the trained machine learning analytical module is stored in a system server memory of the server computer.

In the preferred embodiment, herein, data that are being extracted from the customer relationship management database, the enterprise resource planning database, and the external sources, includes, but not limited to, a historical record of action items, historical and active opportunities data, and direct signals from CPQ systems, and market events from the third-party sources.

In the preferred embodiment, herein, data that are being extracted from the calls log and email database include, but are not limited to, an email and call recordings of sales representative.

In the preferred embodiment, the external sources are the public internet database from where data is being extracted.

A method for an automated suggestion for the next best action in sales, the method having:
the system processing unit of the server computer executes computer-readable instruction to extract data from the customer relationship management database and feed into the trained machine learning analytical module;
the trained machine learning analytical module analyses various information related to the current opportunity and compares with similar opportunities in the past, and further automatically decides the opportunity information that is relevant for making the decision;
the system processing unit of the server computer executes computer-readable instruction to further extract data from the external sources and feed into the trained machine learning analytical module,
the trained machine learning analytical module analysis analyses various information related to opportunities and competition in the external market as well;
the trained machine learning analytical module identifies the next best actions to be taken, and the trained machine learning analytical module identifies those actions also that should not be taken;
the trained machine learning analytical module with help of the system processing unit sends a suggestion to the sales representative on stakeholders to be included in the next best action to be taken;
the trained machine learning analytical module with help of the system processing unit sends the suggestion to the sales representative on the tone of communication to be had with the stakeholders based on previous information;
the trained machine learning analytical module with help of the system processing unit suggests detail activities that need to be undertaken in the next best action; and
the trained machine learning analytical module with help of the system processing unit suggests a deadline for the next best action.

In the preferred embodiment, herein, data from the customer relationship management database that is fed into the trained machine learning analytical module for analysis of various information related to the current opportunity, past opportunity.

In the preferred embodiment, herein, data from the external sources that are fed into the trained machine learning analytical module for analysis are related to competitive intelligence data.

In the preferred embodiment, all the suggestions, content, a reminder that is being sent to the sales representative are sent on a user device that is selected from a desktop computer, a laptop, a tablet, a smartphone, a mobile phone.

A method for automated automatic update of the customer relationship management database, the calls log, and email database, and the enterprise resource planning database, the method having
the trained machine learning analytical module with help of the system processing unit sends a regular reminder to the sales representative for the next best action until the sales representative complete the next best action within the deadline;
the trained machine learning analytical module with help of the system processing unit updates the customer relationship management database, the calls log and email database, the enterprise resource planning database based on the action taken by the sales representative; and
the trained machine learning analytical module with help of the system processing unit also sends higher authorities about the action taken by the sales representative on the suggested next best action and also sends sales representative performance data.

Herein, the trained machine learning analytical module generates suggestions based on analyses of various information related to the current opportunity, past opportunity, and information related to opportunities in the external market.

In an embodiment, the present invention is related to a system and method for automatic updates of customer relationship management and enterprise resource planning fields with the next best actions using machine learning. The method includes:

A method of extracting data, the method having:
one or more system processing units of a server computer, execute computer-readable instructions that use extract, transform, load functions to retrieve data from a customer relationship management database, a calls log and email database, an enterprise resource planning database, and data from external sources;
the one or more system processing units execute computer-readable instruction to create datasets that include past deals history, the action that was taken, final result related to deals;
the one or more system processing units execute computer-readable instruction to refine and quantify the dataset;
further, the one or more system processing units execute computer-readable instruction to integrate all the datasets and feed the datasets into a machine learning analytical module;
thus the machine learning analytical module learns from the datasets;
further, the machine learning analytical module is tested and optimized; and
the trained machine learning analytical module is stored in a system server memory of the server computer.

In the preferred embodiment, herein, data that are being extracted from the customer relationship management database, the enterprise resource planning database, and the external sources, includes, but not limited to, a historical record of action items, historical and active opportunities data, direct signals from CPQ systems, and market events from the third-party sources.

In the preferred embodiment, herein, data that are being extracted from the calls log and email database include, but are not limited to, an email and call recordings of sales representative.

In the preferred embodiment, the external sources are the public internet database from where data is being extracted.

A method for an automated suggestion for the next best action in sales, the method having:
the one or more system processing units of the server computer execute computer-readable instruction to extract data from the customer relationship management database and feed into the trained machine learning analytical module;
   the trained machine learning analytical module analyses various information related to the current opportunity and compares with similar opportunities in the past, and further automatically decides the opportunity information that is relevant for making the decision;
   the one or more system processing units of the server computer execute computer-readable instruction to further extract data from the external sources and feed into the trained machine learning analytical module;
   the trained machine learning analytical module analysis analyses various information related to opportunities and competition in the external market as well;
   the trained machine learning analytical module identifies the next best actions to be taken, and the trained machine learning analytical module identifies those actions also that should not be taken;
   the trained machine learning analytical module with help of the one or more system processing units send a suggestion to the sales representative on stakeholders to be included in the next best action to be taken;
   the trained machine learning analytical module with help of the one or more system processing units send the suggestion to the sales representative on the tone of communication to be had with the stakeholders based on previous information;
   the trained machine learning analytical module with help of the one or more system processing units suggest detail activities that need to be undertaken in the next best action; and
   the trained machine learning analytical module with help of the one or more system processing units suggests a deadline for the next best action.

In the preferred embodiment, herein, data from the customer relationship management database that is fed into the trained machine learning analytical module for analysis of various informations related to the current opportunity, past opportunity.

In the preferred embodiment, herein, data from the external sources that are fed into the trained machine learning analytical module for analysis are related to competitive intelligence data.

In the preferred embodiment, all the suggestions, content, a reminder that is being sent to the sales representative are sent on one or more user devices that are selected from a desktop computer, a laptop, a tablet, a smartphone, a mobile phone.

A method for automated automatic updates of the customer relationship management database, the call log, and email database, and the enterprise resource planning database. The method having
the trained machine learning analytical module with help of the one or more system processing units send a regular reminder to the sales representative for the next best action until the sales representative complete the next best action within the deadline;
the trained machine learning analytical module with help of the one or more system processing units update the customer relationship management database, the calls log and email database, the enterprise resource planning database based on the action taken by the sales representative; and
the trained machine learning analytical module with help of the one or more system processing units also sends higher authorities about the action taken by the sales representative on the suggested next best action and also sends sales representative performance data.

Herein, the trained machine learning analytical module generates suggestions based on analyses of various information related to the current opportunity, past opportunity, and information related to opportunities in the external market.

In the preferred embodiment, the trained machine learning analytical module suggests the next best action to the sales representative along with proper evidence of decision that is a previous decision and effects of that decision in the deal.

In the preferred embodiment, the trained machine learning analytical module suggests the next best action to the sales representative along with proper evidence of decision that is a previous decision and effects of that decision in the deal.

In an embodiment, the method for automatic update of customer relationship management and enterprise resource planning fields with the next best actions using machine learning is being executed with the help of a system. The system includes a customer relationship management database, a calls log and email database, an enterprise resource planning database, a server computer, a user device. The customer relationship management database stores all data related to the company's historical sales and deals, The calls log and email database stores all data related to the historical conversation on emails and calls with customers. The enterprise resource planning database stores all data related to the company operations management, and accounts. The server computer includes a system processing unit and a system server memory. The system processing unit executes computer-readable instructions to automatically update the customer relationship management database and the enterprise resource planning database. The system processing unit further uses the trained machine learning analytical module to suggest the next best action to the sales representative along with proper evidence of decision. The system server memory stores computer-readable instructions and machine learning analytical modules. The user device is connected to the server computer. A user receives the next best action related to sales deals on the user device. Herein, the system processing unit extracts data from the customer relationship management database, the calls log and email database, the enterprise resource planning database, and data from external sources and further trained machine learning analytical module to suggest the next best action to sales representative along with proper evidence of decision. The system processing unit further automatically updates the customer relationship management database, the call log and email database, and the enterprise resource planning database. The customer relationship management database, the call log, and email database, the enterprise resource planning database are all connected to the server computer.

In the preferred embodiment, the external sources are the public internet database from where data is being extracted by the system processing unit.

In an embodiment, the method for automatic update of customer relationship management and enterprise resource planning fields with the next best actions using machine learning is being executed with the help of a system. The system includes a customer relationship management database, a calls log and email database, an enterprise resource planning database, a server computer, one or more user devices. The customer relationship management database stores all data related to the company's historical sales and deals, The calls log and email database stores all data related to the historical conversation on emails and calls with customers. The enterprise resource planning database stores all data related to the company operations management, and accounts. The server computer includes one or more system processing units and a system server memory. The one or more system processing units execute computer-readable instructions to automatically update the customer relationship management database and the enterprise resource planning database. One or more system processing units further use the trained machine learning analytical module to suggest the next best action to the sales representatives along with proper evidence of decision. The system server memory stores computer-readable instructions and machine learning analytical modules. The one or more user devices are connected to the server computer. A user receives the next best action related to sales deals on one or more user devices. Herein, the one or more system processing units extract data from the customer relationship management database, the calls log and email database, the enterprise resource planning database, and data from external sources and further trained machine learning analytical module to suggest the next best action to sales representative along with proper evidence of decision. The one or more system processing units further automatically update the customer relationship management database, the calls log and email database, and the enterprise resource planning database. The customer relationship management database, the call log, and email database, the enterprise resource planning database are all connected to the server computer. In the preferred embodiment, the external sources are the public internet database from where data is being extracted by one or more system processing units.

Further objectives, advantages, and features of the present invention will become apparent from the detailed description provided herein, in which various embodiments of the disclosed present invention are illustrated by way of example and appropriate reference to accompanying drawings. Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings.

I/We claim:

1. A method for automatic update of customer relationship management and enterprise resource planning fields with next best actions using machine learning, the method comprising:
a method of extracting data, the method having
an at least one system processing unit (106) of a server computer (104), executes computer-readable instructions that use extract, transform, load functions to retrieve data from a customer relationship management database (102), a calls log and email database (108), an enterprise resource planning database (110), and data from external sources,
the at least one system processing unit (106) executes computer-readable instruction to create datasets that include past deals history, the action that was taken, final result related to deals,
the at least one system processing unit (106) executes computer-readable instruction to refine and quantify the dataset,
further, the at least one system processing unit (106) executes computer-readable instruction to integrate all the datasets and feed the datasets into a machine learning analytical module,
thus the machine learning analytical module learns from the datasets,
further, the machine learning analytical module is tested and optimized, and
the trained machine learning analytical module is stored in a system server memory (120) of the server computer (104); and
a method for an automated suggestion for next best action in sales, the method having
the at least one system processing unit (106) of the server computer (104) executes computer-readable instruction to extract data from the customer relationship management database (102) and feed into the trained machine learning analytical module,
the trained machine learning analytical module analyses various information related to the current opportunity and compares with similar opportunities in the past, and further automatically decides the opportunity information that is relevant for making the decision,
the at least one system processing unit (106) of the server computer (104) executes computer-readable instruction to further extract data from the external sources and feed into the trained machine learning analytical module,
the trained machine learning analytical module analysis analyses various information related to opportunities and competition in the external market as well,
the trained machine learning analytical module identifies the next best actions to be taken, and the trained machine learning analytical module identifies those actions also that should not be taken,
the trained machine learning analytical module with help of the at least one system processing unit (106) sends a suggestion to the sales representative on stakeholders to be included in the next best action to be taken,
the trained machine learning analytical module with help of the at least one system processing unit (106) sends the suggestion to the sales representative on the tone of communication to be had with the stakeholders based on previous information,
the trained machine learning analytical module with help of the at least one system processing unit (106) suggests detail activities that need to be undertaken in the next best action, and
the trained machine learning analytical module with help of the at least one system processing unit (106) suggests a deadline for the next best action;
a method for automated automatic update of the customer relationship management database (102), the calls log and email database (108), and the enterprise resource planning database (110), the method having
the trained machine learning analytical module with help of the at least one system processing unit (106) sends a regular reminder to the sales representative for the next best action until the sales representative complete the next best action within the deadline,
the trained machine learning analytical module with help of the at least one system processing unit (106) updates the customer relationship management database (102), the calls log and email database (108), the enterprise resource planning database (110) based on the action taken by the sales representative, and
the trained machine learning analytical module with help of the at least one system processing unit (106) also sends higher authorities about the action taken by the sales representative on the suggested next best action and also sends sales representative performance data;
wherein, the trained machine learning analytical module generates suggestions based on analyses of various information related to the current opportunity, past opportunity, and information related to opportunities in the external market.

2. The method as claimed in claim 1, wherein, data that are being extracted from the customer relationship management database (102), the enterprise resource planning database (110), and the external sources, are selected from, but not limited to, a historical record of action items, historical and active opportunities data, direct signals from CPQ systems, and market events from the third-party sources.

3. The method as claimed in claim 1, wherein, data that are being extracted from the calls log and email database (108) are selected from, but not limited to, email and call recordings of sales representative.

4. The method as claimed in claim 1, wherein, data from the customer relationship management database (102) is fed into the trained machine learning analytical module for analysis of various information related to the current opportunity, past opportunity.

5. The method as claimed in claim 1, wherein, the external sources are the public internet database (118) from where data is being extracted.

6. The method as claimed in claim 1, wherein, data from the external sources that are fed into the trained machine learning analytical module for analysis are related to competitive intelligence data.

7. The method as claimed in claim 1, wherein, all the suggestion, content, a reminder that is being sent to the sales representative are sent on an at least one user device (112) that is selected from a desktop computer, a laptop, a tablet, a smartphone, a mobile phone.

8. The method as claimed in claim 1, wherein, the trained machine learning analytical module suggests the next best action to sales representative along with proper evidence of decision that is a previous decision and effects of that decision in the deal.

9. The method as claimed in claim 1, wherein the method for automatic update of customer relationship management and enterprise resource planning fields with next best actions using machine learning is being executed with the help of a system (100), the system (100) comprising:
the customer relationship management database (102), the customer relationship management database (102) stores all data related to the company's historical sales and deals;
the calls log and email database (108), calls log and email database (108) stores all data related to a historical conversation on emails and calls with customers;
the enterprise resource planning database (110), the enterprise resource planning database (110) stores all data related to the company operations management, and accounts;
the server computer (104), the server computer (104) having
the at least one system processing unit (106), the at least one system processing unit (106) executes computer-readable instructions to automatically update the customer relationship management database (102) and the enterprise resource planning database (110), and further use the trained machine learning analytical module to suggest next best action to sales representative along with proper evidence of decision,
the system server memory (120), the system server memory (120) stores computer-readable instructions and machine learning analytical module; and
the at least one user device (112), the at least one user device (112) is connected to the server computer (104), a user receives next best action related to sales deal on the at least one user device (116);
wherein, the at least one system processing unit (106) extracts data from the customer relationship management database (102), the calls log and email database (108), the enterprise resource planning database (110), and data from external sources and further trained machine learning analytical module to suggest next best action to sales representative along with proper evidence of decision and further automatically update the customer relationship management database (102), the calls log and email database (108), and the enterprise resource planning database (110),
wherein, the customer relationship management database (102), the call log, and email database (108), the enterprise resource planning database (110) are all connected to the server computer (104).
